(19) United States
(12) Patent Application Publication
(10) Pub. No.: US 2023/0121622 A1
(43) Pub. Date: Apr. 20, 2023

(54) SADDLE CARRYING AND HOLDING APPARATUS

(71) Applicant: Sylvain Roy, Stony Plain (CA)

(72) Inventor: Sylvain Roy, Stony Plain (CA)

(21) Appl. No.: 17/451,485

(22) Filed: Oct. 19, 2021

(51) Int. Cl. A45F 3/04

(52) U.S. Cl. CPC A45F 3/04; B68C 1/00

(57) ABSTRACT

A saddle carrying apparatus that is configured to assist a user in carrying a saddle as well as provide horizontal positioning of the saddle in its second mode. The present invention includes an outer body that comprises a shell like exterior manufactured from nylon or similar material. The outer body includes three sections that are integrally formed and shaped so as to create an interior volume that mateably accommodates a saddle therein. Disposed within the interior volume is a rack member. The rack member is configured to be secured to a wall or other support structure and provide the saddle in a horizontal position. The rack member includes a wall engagement member and a saddle support member. The outer body includes shoulder straps and at least one grab handle. The wall engagement member and saddle support member can be hingedly coupled.

### FIELD OF THE INVENTION

The present invention relates generally to equine accessories, more specifically but not by way of limitation, a transport bag that is configured to provide improved transport of an English style saddle and further provide elements that function as a saddle rack BACKGROUND

Equestrian activities are quite popular and are participated in by thousands of people. There are numerous styles and types of equine-based sports that include but are not limited to jumping, rodeo and dressage. As can be understood, most of the equine-based sporting activities requires a great deal of equipment. One such piece of equipment that is typically fit to a user is a saddle. There are generally two types of saddles referred to as western and English. The type of saddle used is based on the activity for which the rider and horse will participate. Both types of saddles are typically quite expensive and as such many times the rider will transport the saddle back and forth to the area or facility in which they ride their horse.

One issue with transportation of saddles is that they are quite cumbersome and can weigh a significant amount. The carrying of these saddles is quite difficult and can result in inconveniences for the rider. While there are some duffel style bags for assisting in carrying the saddles, they offer little except in solely just providing coverage thereof and somewhat of an improved technique to provide grasping and transportation. It is common for a rider to place their saddle on a rack once at the facility and no existing technology provides the convenience of incorporation of a rack with a transportation bag or similar article.

Accordingly, there is a need for a saddle carrying and holding apparatus that provides an element to assist in the carrying of a saddle and further provides an integrated rack operable to facilitate an ability to store the saddle on a rack when not being transported.

### SUMMARY OF THE INVENTION

It is the object of the present invention to provide a saddle carrying and holding apparatus that is configured to assist in transportation of a saddle and provide a rack to store wherein the present invention includes an outer body.

Another object of the present invention is to provide a carry container for an English style saddle wherein the carry container includes an integrated rack wherein the body includes three integral portions shaped to accommodate a saddle in the interior volume thereof.

A further object of the present invention is to provide a saddle carrying and holding apparatus that is configured to assist in transportation of a saddle and provide a rack to store wherein the body includes a plurality of zipper or similar elements configured to provide access to the interior volume.

Still another object of the present invention is to provide a carry container for an English style saddle wherein the carry container includes an integrated rack wherein disposed within the interior volume is a rack member configured to provide support for a saddle.

An additional object of the present invention is to provide a saddle carrying and holding apparatus that is configured to assist in transportation of a saddle and provide a rack to store wherein the rack member includes a wall engagement member operably to suspendedly mount the rack member on a vertical wall or similar structure.

Yet a further object of the present invention is to provide a carry container for an English style saddle wherein the carry container includes an integrated rack wherein the rack member includes a saddle support member extending axially underneath the saddle ensuing engagement therewith.

Another object of the present invention is to provide a saddle carrying and holding apparatus that is configured to assist in transportation of a saddle and provide a rack to store wherein the body includes a first lateral wing portion and a second lateral wing portion.

Still an additional object of the present invention is to provide a carry container for an English style saddle wherein the carry container includes an integrated rack wherein the first lateral wing portion and second lateral wing portion have a waist band member operably coupled therebetween.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a side view of an embodiment of the present invention; and

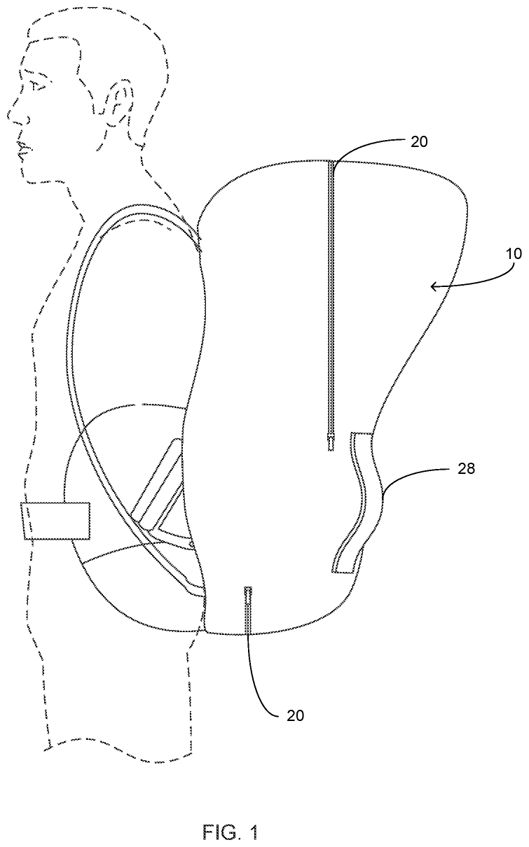

FIG. 2 is a side view of the present invention showing the rack member therein; and

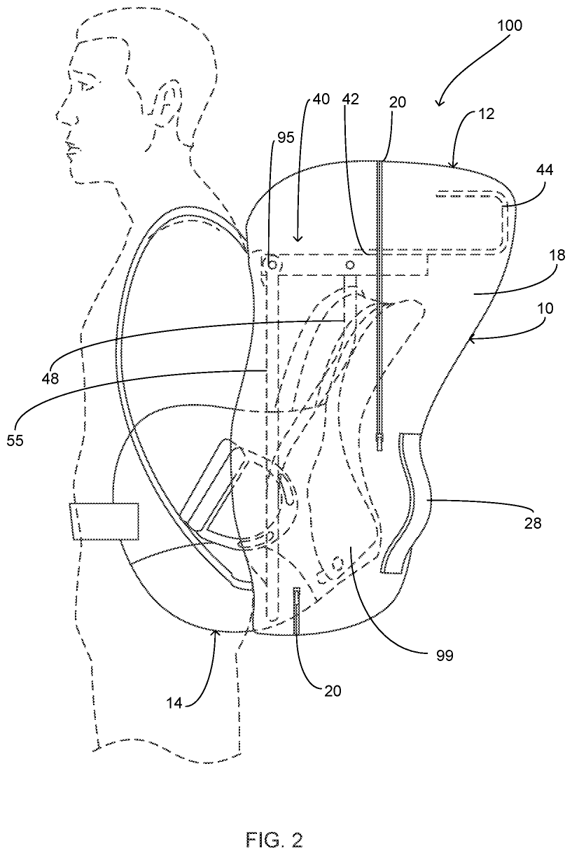

FIG. 3 is a front view of the present invention being worn by a user.

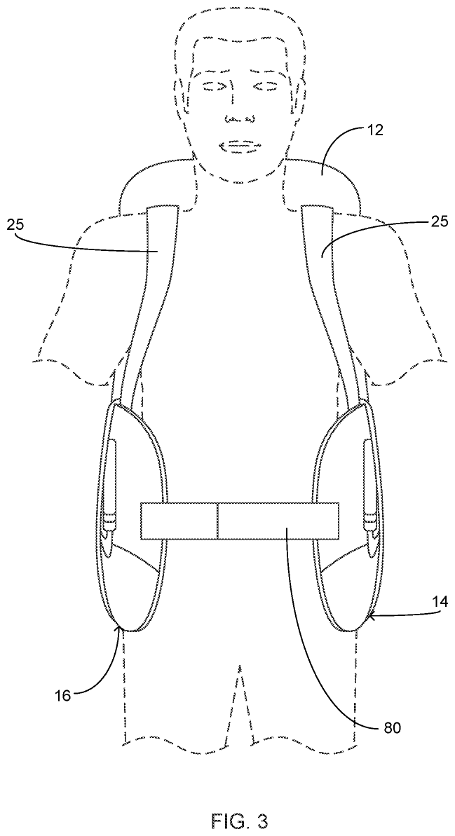

### DETAILED DESCRIPTION

Referring now to the drawings submitted herewith, wherein various elements depicted therein are not necessarily drawn to scale and wherein through the views and figures like elements are referenced with identical reference numerals, there is illustrated a saddle carrying apparatus 100 constructed according to the principles of the present invention.

An embodiment of the present invention is discussed herein with reference to the figures submitted herewith. Those skilled in the art will understand that the detailed description herein with respect to these figures is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment”, “an embodiment”, “exemplary embodiments”, and the like may indicate that the embodiment(s) of the invention so described may include a particular feature, structure or characteristic, but not every embodiment necessarily includes the particular feature, structure or characteristic.

Referring in particular to Figures submitted as a part hereof, the saddle carrying apparatus 100 includes an outer body 10. The outer body 10 is manufactured from a lightweight durable material such as but not limited to nylon. The outer body 10 includes a center section 12, a first lateral wing section 14 and a second lateral wing section 16. The center section 12, first lateral wing section 14 and second lateral wing section 16 are contiguously formed utilizing suitable techniques and are formed to create a single interior volume 18. The center section 12, first lateral wing section 14 and second lateral wing section 16 are formed to create a specific shape for the interior volume 18 so as to mateably receive an English saddle. The first lateral wing section 14 and second lateral wing section 16 are proximate the bottom of the center section 12 and extend outward therefrom. The position of the first lateral wing section 14 and second lateral wing section 16 are positioned so as to place the saddle flaps of the English saddle on opposing sides of the hips of the user ensuing the saddle carrying apparatus 100 being secured to the back of the user. This configuration improves a user's ability to more easily transport the English saddle as a portion thereof is surroundably mounted to the wearer.

The outer body 10 includes access zippers 20. The access zippers 20 are configured to remove the outer body 10 from the saddle 99 disposed therein allowing access thereto. The zippers 20 are positioned on the top of the center section 12 and the bottom of the center section 12. The outer body 10 is substantially removed from the saddle 99 when a user desires to use the saddle carrying apparatus 100 in its second mode wherein the saddle carrying apparatus 100 is secured to a suitable support structure to place the saddle 99 is a horizontal position as will be further discussed herein. It should be understood within the scope of the present invention that the saddle carrying apparatus 100 could employ various amounts of zippers or similar elements to facilitate the ability to access the interior volume 18. By way of example but not limitation, the outer body 10 could employ one perimeter zipper or have a plurality of zippers configured to achieve the desired functionality. Secured to the exterior surface of the body 10 utilizing suitable techniques are the shoulder straps 25 and handles 28. The shoulder straps 25 are placed so as to facilitate a user to be able to don the saddle carrying apparatus 100 on their shoulders. Handles 28 provide an additional technique to grasp the saddle carrying apparatus 100 and move as desired. It should be understood within the scope of the present invention that the outer body 10 could have more than one handle 28 secured thereto.

Disposed within the interior volume 18 is the rack member 40. The rack member 40 is configured to provide support of the saddle 99 and position the saddle 99 in a horizontal orientation. The rack member 40 includes a wall engagement member 42 having hook member 44 at the end thereof. The wall engagement member 42 and hook member 44 are contiguously formed utilizing suitable techniques and are manufactured from a lightweight rigid material such as but not limited to metal. The hook member 44 is u-shaped and is configured to be superposed a suitable structure such as but not limited to a top of a knee wall. The wall engagement member 42 extends downward along the wall wherein the two provide the necessary structure to support the weight of the saddle 99. A secondary support member 48 is operably coupled between the wall engagement member 42 and the saddle support member 55. The secondary support member 48 is manufactured from a lightweight metal and is formed to engage the saddle 99 and provide support thereof in both the first mode and second mode of the saddle carrying apparatus 100.

The rack member 40 further includes a saddle support member 55. The saddle support member 55 is perpendicular to the wall engagement member 42 and operably coupled thereto. The saddle support member 55 is manufactured from a lightweight rigid metal or similar material and extends approximate the length between the pommel and cantle of the saddle 99. The saddle support member 55 is hingedly attached to the wall engagement member 42 utilizing fastener 95. Hingedly securing the wall engagement member 42 and saddle support member 55 facilitates the ability to fold the saddle carrying apparatus 100 when not in use. It should be understood within the scope of the present invention that the wall engagement member 42 and saddle support member 55 could be immovably coupled. While not particularly illustrated herein, it is contemplated within the scope of the present invention that a foam or gel insert could be adjacent the saddle support member 55 so as to adjacent the spine of the wearer in order to provide a more comfortable wearing experience.

The outer body 10 further includes a waist strap member 80. The waist strap member 80 is secured to the first lateral wing section 14 and second lateral wing section 16 utilizing suitable techniques. The waist strap member 80 is manufactured from nylon or other suitable material and is employed to assist in releasably securing the first lateral wing section 14 and second lateral wing section 16 around a wearer's waist when transporting the saddle carrying apparatus 100.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A saddle carrying and support apparatus comprising:
a body, said body having an exterior wall forming a shape thereof, said body having an upper end and a lower end, said body having an interior volume, said interior volume configured to mateably receive a saddle;
a rack member, said rack member being secured within said interior volume of said body, said rack member having a wall engagement member and a saddle support member, said wall engagement member and said saddle support member being perpendicular to each other; and
wherein the saddle carrying apparatus is operable in a first mode and a second mode wherein in said first mode the body is secured to a back of a wearer.

2. The saddle carrying and support apparatus as recited in claim 1, wherein said wall engagement member further includes a hook member, said hook member configured to operably coupled to a support structure so as to place the saddle rack member in a horizontal position.

3. The saddle carrying and support apparatus as recited in claim 2, and further including a secondary support member, said secondary support member being operably coupled intermediate said wall engagement member and said saddle support member.

4. The saddle carrying and support apparatus as recited in claim 3, wherein in said second mode said hook member is engaged with a support structure and said saddle support member is in a horizontal position.

5. The saddle carrying and support apparatus as recited in claim 4, wherein said body has secured to an exterior surface a pair of shoulder straps.

6. The saddle carrying and support apparatus as recited in claim 5, wherein said body has secured to the exterior surface thereof at least one grab handle.

7. The saddle carrying and support apparatus as recited in claim 6 wherein the body has at least one zipper providing access to the interior volume thereof.

8. The saddle carrying and support apparatus as recited in claim 7, wherein the wall engagement member and the saddle support member are movably coupled.

9. A saddle carrying and support apparatus configured to provide a first mode of use and a second mode of use wherein the saddle carrying and support apparatus comprise:
a body, said body having an exterior wall forming a shape thereof, said body having an upper end and a lower end, said body having a center section, a first lateral wing section and a second lateral wing section, said center section, said first lateral wing section and said second lateral wing section being contiguously formed to create an interior volume that will mateably accommodate an English saddle, said body having secured to the exterior wall thereof at least one grab handle, said body further having at least one zipper in the exterior wall thereof;
a rack member, said rack member being disposed within said interior volume of said body, said rack member having a wall engagement member and a saddle support member, said wall member having a hook member integrally formed on a first end thereof, said wall engagement member and said saddle support member being perpendicular to each other, said wall engagement member and said saddle support member being moveably coupled; and
wherein in said second mode said hook member and said wall engagement member are operably coupled to a support structure so as to place said saddle support member in a horizontal position.

10. The saddle carrying and support apparatus as recited in claim 9, wherein said body has secured to an exterior surface a pair of shoulder straps.

11. The saddle carrying and support apparatus as recited in claim 10, wherein said body further includes a waist strap member, said waist strap member operably coupled intermediate said first lateral wing member and said second lateral wing member.

12. The saddle carrying and support apparatus as recited in claim 11, and further including a secondary support member, said secondary support member being operably coupled intermediate said wall engagement member and said saddle support member, said secondary support member having an curved section being proximate a bottom of a saddle disposed within said interior volume.

13. The saddle carrying and support apparatus as recited in claim 12, wherein said hook member is u-shaped.

14. The saddle carrying and support apparatus as recited in claim 13, wherein said body is manufactured from nylon.
